(19) United States
(12) Patent Application Publication
(10) Pub. No.: US 2002/0095374 A1
(43) Pub. Date: Jul. 18, 2002

(54) Method and apparatus for processing cash payments for electronic and internet transactions

(76) Inventor: Robert Lynn Ellis, Sacramento, CA (US)

Correspondence Address: DAVIS & ASSOCIATES, P.O. BOX 1093, DRIPPING SPRINGS, TX, 78620, US

(21) Appl. No.: 10/036,339

(22) Filed: Dec. 26, 2001

Related U.S. Application Data
(60) Provisional application No. 60/258,908, filed on Dec. 26, 2000.

(51) Int. Cl. G06F 17/60

(52) U.S. Cl. 705/39

(57) ABSTRACT

A method of enabling cash payments for e-commerce transactions includes the step of providing a cash acceptance device at a point of presence. Upon depositing cash with the cash acceptance device, the amount of cash received for a selected transaction is communicated to a server geographically distinct from the point of presence. The selected transaction is executed in accordance with whether the amount received is greater than or equal to the amount required for the selected transaction.

### CROSS-REFERENCE TO RELATED APPLICATION

This application claims the benefit of provisional patent application No. 60/258,908 filed Dec. 26, 2000 entitled “System and Method of Cash Payment for Electronic and Internet Transactions” of Robert Lynn Ellis.

### FIELD OF THE INVENTION

This invention relates to the field of electronic commerce. In particular, this invention is drawn to cash payments for electronic and Internet financial transactions.

### BACKGROUND OF THE INVENTION

Internet based commerce has evolved significantly over a fairly short timeline. Speed, security, and efficiency of processing orders and payments, for example, have been significantly improved. Nonetheless, vendors and consumers are exposed to risks that do not exist at point-of-presence sales.

In a traditional point-of-presence sale, the consumer typically has many options for payment. Moreover, when debit or credit accounts are drawn upon for the transaction, the consumer is required to present identification either electronically (e.g., personal identification number) or some other corroborating proof of identity such as a picture identification. Credit transactions also usually require the signature of the consumer for confirmation that the purchase is authorized. These additional steps protect both the consumer and the merchant or vendor.

One advantage of Internet transactions is the lack of any requirement for geographical proximity between seller and purchaser. Due to the impracticality of obtaining signatures or presenting picture identification, such requirements are largely dispensed with for Internet transactions despite the risks of doing so. Payment for orders is handled predominately through the use of pre-existing debit (i.e., funded) or third party credit accounts without the use of signatures or personal identification numbers (PIN) normally used to confirm identity of the consumer or to otherwise reduce unauthorized use.

From the consumer's standpoint, the credit, check, or debit card information may not be secure during or even after the transaction. At the time of the transaction, the information is communicated over an insecure, public network thus exposing the consumer to the risk that the information may be shared with a malicious eavesdropper. After the transaction, the consumer's financial information might not be secure from unauthorized malicious third parties using the same public network to retrieve the financial information from the vendor. The consumer has little ability to control the safekeeping of such information during or after the transaction. Moreover, the security risk may exist for years after the transaction.

Despite their disadvantages, the use of credit, debit, and check cards is prevalent for electronic and Internet transactions. Even if consumers consider the risks acceptable, the ability to obtain third party credit or to obtain or maintain a bank account is a pre-requisite to being able to participate in such transactions. Even if merchants consider the risks acceptable, consumers may refuse to obtain third party credit, maintain a banking account, or to entrust their financial information to the vendor. As a result many consumers are disenfranchised from being able to participate in such commercial transactions to the detriment of both the merchants and the consumers.

### SUMMARY OF THE INVENTION

In view of limitations of known systems and methods, methods and apparatus enabling cash payments for e-commerce transactions are disclosed.

A method of enabling cash payments for e-commerce transactions includes the step of providing a cash acceptance device at a point of presence. Upon depositing cash with the cash acceptance device, the amount of cash received for a selected transaction is communicated to a server geographically distinct from the point of presence. The selected transaction is executed in accordance with whether the amount received is greater than or equal to the amount required for the selected transaction.

An apparatus for enabling cash payments for e-commerce transactions includes a cash acceptor, wherein the cash acceptor validates and tallies received cash. A processor is coupled to communicate the amount of cash received to a geographically distinct server for application to a selected transaction. The processor generates a receipt indicating the outcome of the transaction in response to the server.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates a tiered architecture for Internet based transactions.

FIG. 2 illustrates one embodiment of a process for handling cash based e-commerce transactions.

FIG. 3 illustrates a specific application of the process of FIG. 1 using the architecture of FIG. 1.

FIG. 4 illustrates one embodiment of a point of presence kiosk for accepting cash.

### DETAILED DESCRIPTION

As an alternative to credit, debit, and checking account purchases, methods and apparatus for facilitating Internet or other electronic commerce transactions when payment is made in cash are provided.

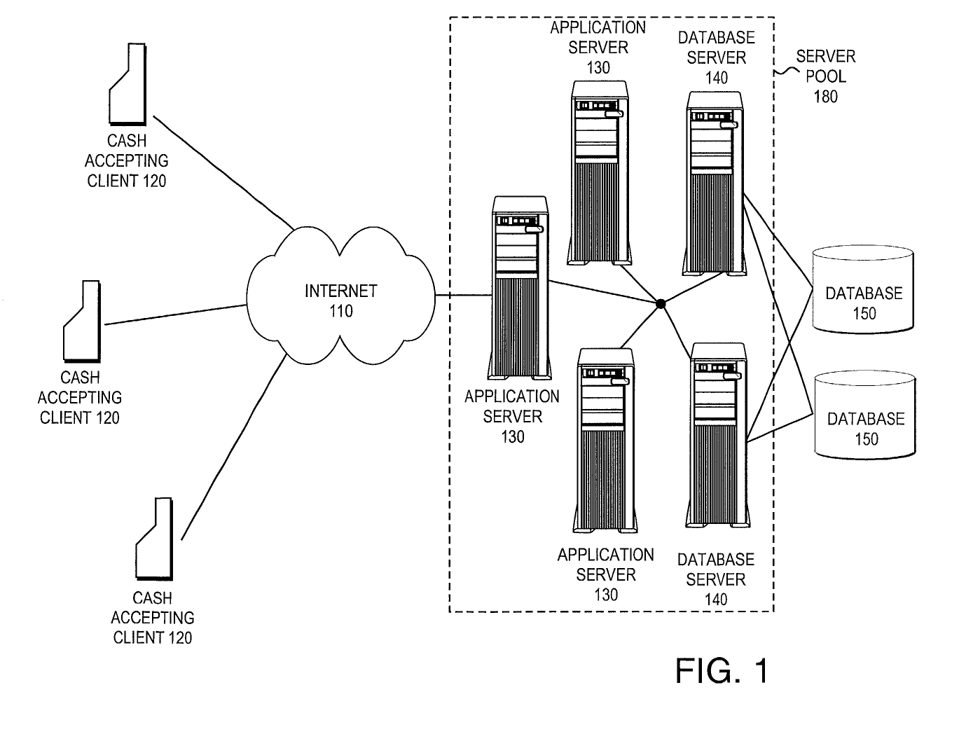

FIG. 1 illustrates a three tier transaction processing architecture. The three tier architecture is a distributed architecture and has become a prevalent architecture in Internet commerce. The cash accepting client machine 120 represents the first tier of the architecture. In one embodiment, the client machine is an automated kiosk. An automated teller machine (ATM) is an example of an automated kiosk.

The first tier provides consumers with a front-end interface to the application servers 130. The front-end interface includes the user interface and related services such as session, text input, dialog, and display management. In one embodiment (e.g., Internet applications), the frontend is a software application referred to as a “browser” that is executing on the client machine 120. The browser application provides a graphical user interface that enables the user to navigate to and request different resources accessible through the Internet.

The second or middle tier represented by application servers 130 provides process management where the business logic is executed. Validation of a client machine issued request, for example, is one example of processing handled by the application server. The middle tier also provides functions such as queuing, application execution, and database staging. A communications medium such as the Internet 110 enables client machines 120 (e.g., kiosks, ATMs, etc.) to communicate with one or more application servers 130. The application server 130 is typically handling requests from multiple users in an asynchronous manner. The application servers are stateless but have side-effects on the databases which maintain the status of the selected transaction. Although the application servers are stateless, they have side-effects on the databases 150.

The third tier includes databases 150 and database servers 140 which are collectively referred to as the database unless explicitly indicated otherwise. The database server functionality may be incorporated into the application servers for lower transactional volumes. Multiple application servers and database servers, however, may be grouped together as a server pool 180 for handling higher transactional volumes. The third tier provides database management services including data locking, consistency, and replication services to ensure that data is consistent throughout the distributed environment. The application servers 130 execute database queries and updates to databases 150 through database servers 140. After processing a client submitted request, the application server returns the result to the appropriate client. The result, for example, may be provided to the client in the form of a receipt to indicate the status of the transaction.

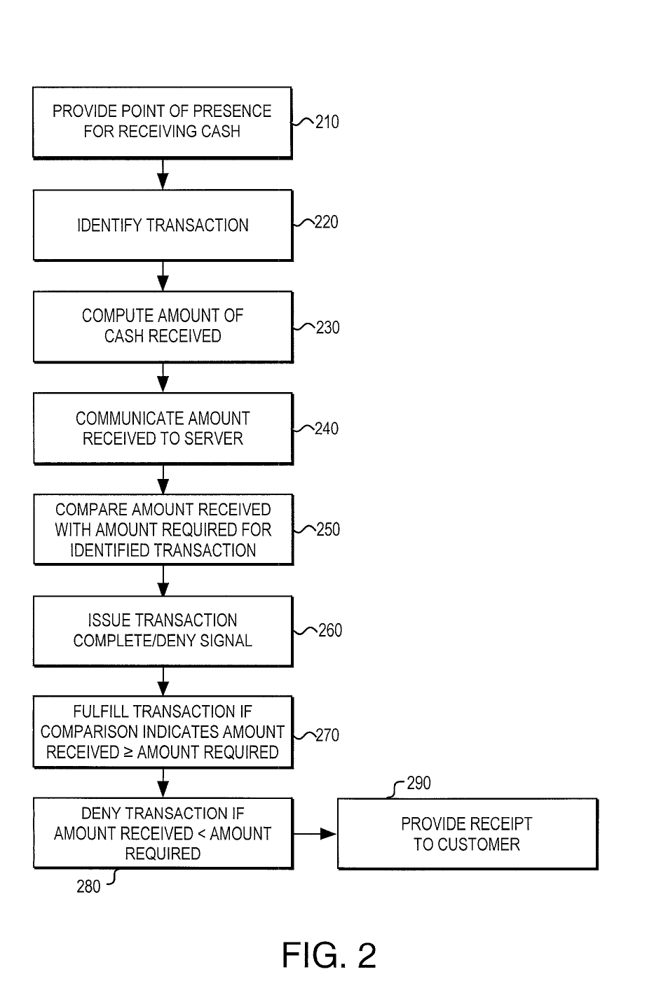

FIG. 2 illustrates basic functions required to facilitate cash based ecommerce transactions. In step 210, a point-of-presence is provided for receiving cash deposits. “Cash” refers to money in the form of coin or negotiable paper such as paper money, money order, or check. The point of presence may be embodied, for example, by an automated kiosk such as an ATM.

In step 220, a transaction is identified for execution. The transaction to be executed may be initiated at the time cash is deposited. Alternatively, the transaction may consist of a suspended order awaiting payment for execution. For example, numerous vendors permit adding goods or services to a “shopping cart” which is preserved until the consumer is ready to “check out” by paying for items in the shopping cart. The shopping cart is treated as a suspended order until payment is processed. The transaction identified for execution may thus be associated with an ecommerce shopping cart representing a suspended order.

Step 230 computes the amount of cash received in step 210. Step 230 inherently requires validation to ensure no bogus money is attributable to the amount received. Numerous products are available for automated authentication of cash such as government issued paper or coin money.

The validated amount received is communicated to a server in step 240. The server may be geographically remote from the point of presence. The goods or services identified by the selected transaction may likewise be located or provided from a source remote from the point of presence.

The server compares the amount received with the amount required to execute the identified transaction in step 250 and issues a transaction complete/deny signal in step 260. If the amount received is greater than or equal to the amount required, then the transaction can be fulfilled in step 270. If the amount received is less than the amount required, then completion of the transaction is denied in step 280. The customer is provided with a receipt identifying the transaction and the completion status in step 290.

Fulfillment of the transaction may include notifying the vendor that appropriate payment has been received so that the vendor may transfer the order from suspended to active status for processing. This may be appropriate, for example, when the server/database system processing the cash payment is distinct from the vendor server/database system maintaining the suspended order (i.e., the cash payment processing entity is distinct from the entity with which the order is being placed). In one embodiment, fulfillment results in providing the consumer with an activation code to enable a good or activate a service. The activation code may be indicated, for example, on the receipt provided to the consumer.

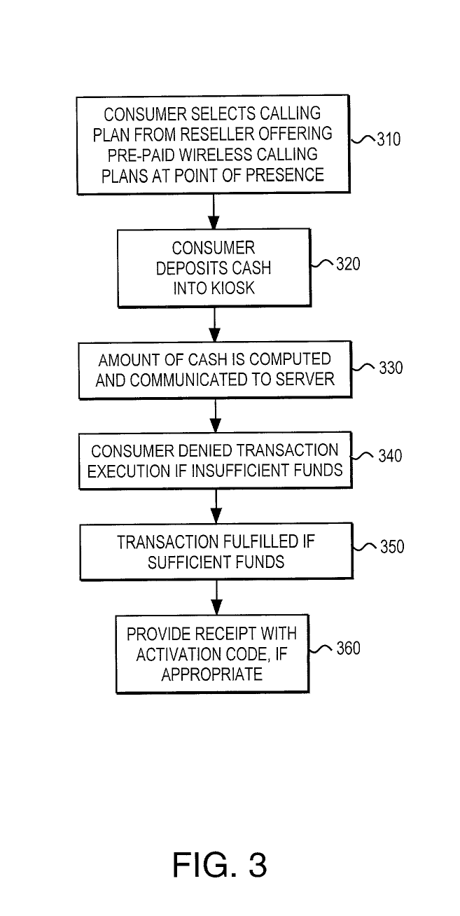

FIG. 3 illustrates a specific application of the process of FIG. 2 using the tiered architecture of FIG. 1. In step 310, a consumer selects a desired calling plan from a reseller offering pre-paid wireless calling plans at the point of presence (steps 210-220 of FIG. 2). The consumer deposits cash into the kiosk or ATM in step 320. The amount of cash deposited is computed and communicated to a server in step 330 (steps 230-240 of FIG. 2). If the deposited cash is less than the amount required for the selected transaction, the transaction is denied in step 340 (steps 260, 280 of FIG. 2).

If, however, the deposited cash is at least as much as the amount required for the selected transaction, the transaction is fulfilled in step 350 (steps 260, 270 of FIG. 2). The consumer is provided with a receipt in step 360 to indicate the status of the transaction.

In one embodiment, an activation code is printed on the receipt when a transaction is successfully completed. The activation code, for example, may enable the consumer to utilize a cellular phone for a number of minutes determined by the transaction selected. The consumer provides the activation code to the wireless service provider to extend service for the designated number of minutes.

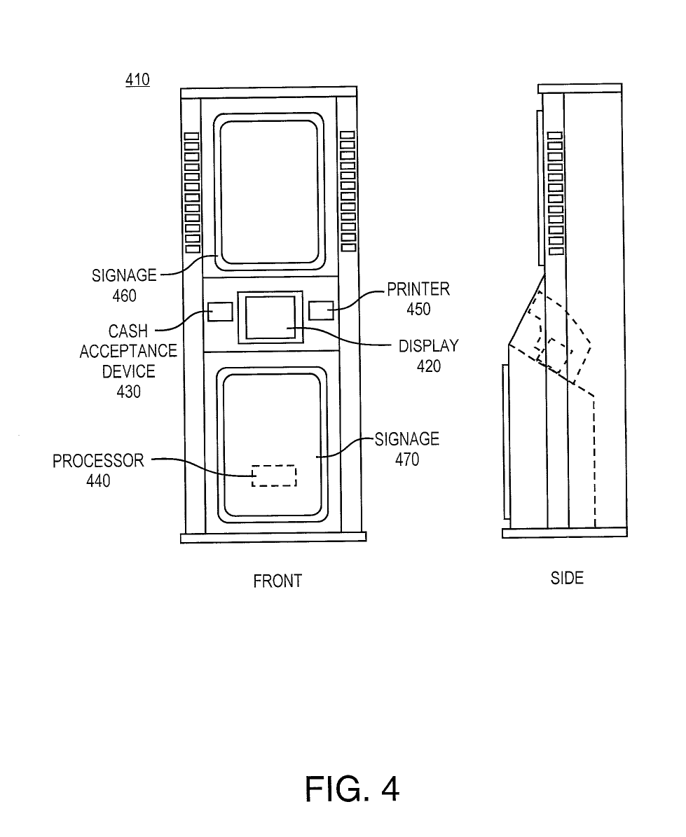

FIG. 4 illustrates one embodiment of a cash acceptance device 410. The cash acceptance device is designed as an automated kiosk. The kiosk 410 includes a display 420 to enable the user to select a transaction. In one embodiment, the display is a touch sensitive graphical user interface. In various embodiments, the kiosk may also include signage (e.g., 460, 470). The signage may provide instruction as to the use or operation of the kiosk. Alternatively, the signage may be used for advertisement.

Kiosk 410 includes a cash acceptance device 430. Cash acceptance device 430 validates and tallies received cash. In one embodiment, cash is limited to government issued paper money and coin. Alternatively, cash may include other paper instruments such as checks and money orders that can be validated upon presentment.

Kiosk 410 further includes a processor 440 for communicating information including the selected transaction and the amount of cash received to a geographically distinct server. In one embodiment, the processor may also communicate status information such as number of attempted deposits, hours of continuous operation, detected tampering, etc. to the server. In one embodiment, the same processor is performing the validation and tallying function of the cash acceptance device.

The kiosk 410 also includes a printer 450 for generating a receipt indicating the completion status of the transaction. The receipt may indicate, for example, the selected transaction, the date and time of the deposit, the amount of deposit, whether the transaction was completed or denied, and the amount of money retained or refunded or to be refunded to the depositor. In the event the transaction is completed, the receipt may also indicate, for example, the specific goods or services ordered, when delivery or performance is expected, and a reference number for subsequent status inquiries. If, for example, airline tickets or airfare is the subject matter of the transaction, the receipt might include the itinerary for the booked flight(s) and a confirmation code.

In one embodiment, processor 440 instructs the cash acceptance device to return the amount deposited if the transaction is denied. In an alternative embodiment, the processor instructs the printer to generate a receipt indicating the amount of cash deposited so that the depositor may present the receipt at another location for refund in the event of a denied transaction.

The use of cash enables consumers who refuse or are unable to maintain bank accounts or establish third party credit accounts to participate in Internet financial transactions. Other consumers may have such accounts but have apprehensions about providing sensitive financial information over a publicly accessible network or have concerns about security of the account information after the transaction. These other consumers may likewise participate in e-commerce transactions while refraining from providing any other financial information for the transaction. A considerably larger group of consumers is thus enabled to participate in e-commerce transactions, particularly Internet based e-commerce.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of conducting a financial transaction, comprising the steps of:
a) providing a cash acceptance device at a point of presence;
b) communicating an amount of cash received for a selected transaction to a server geographically distinct from the point of presence; and
c) executing the selected transaction if the amount received is greater than or equal to the amount required for the selected transaction.

2. The method of claim 1 wherein step b) further comprises the step of validating deposited cash.

3. The method of claim 2 wherein cash is at least one of a government issued paper money or coin.

4. The method of claim 2 wherein cash is at least one of a check and a money order.

5. The method of claim 1 wherein the selected transaction is for the purchase of a good.

6. The method of claim 1 wherein the selected transaction is for the purchase of a service.

7. The method of claim 1 wherein step c) further comprises the step of providing an activation code to the depositor if the amount received is greater than or equal to the amount required for the selected transaction, wherein the activation code permits the depositor to enable a good or activate a service that is the subject matter of the transaction.

8. An apparatus for conducting e-commerce transactions comprises:
a cash acceptor, wherein the cash acceptor validates and tallies received cash; and
a processor coupled to communicate the amount of cash received to a geographically distinct server for application to a selected transaction, wherein responsive to the server the processor generates a receipt indicating an outcome of the transaction.

9. The apparatus of claim 8 further comprising:
a printer for printing the receipt.

10. The apparatus of claim 8 further comprising:
a display having a graphical user interface for interactive identification of the selected transaction.

11. The apparatus of claim 8 wherein the processor is coupled to the geographically distinct server by Internet.
